(19) United States
(12) Patent Application Publication
(10) Pub. No.: US 2024/0066438 A1
(43) Pub. Date: Feb. 29, 2024

(54) LIQUID FILTER ELEMENT AND ASSEMBLY

(71) Applicant: Baldwin Filters, Inc., Cleveland, OH (US)

(72) Inventors: James Roussel, Ravenna, NE (US); Farrell Calcaterra, Kearney, NE (US); Stephen W. Schweitzer, Kearney, NE (US); Steven J. Merritt, Kearney, NE (US)

(73) Assignee: Baldwin Filters, Inc., Cleveland, OH (US)

(21) Appl. No.: 18/502,598

(22) Filed: Nov. 6, 2023

Related U.S. Application Data
(63) Continuation of application No. PCT/US2022/027884, filed on May 5, 2022.
(60) Provisional application No. 63/306,746, filed on Feb. 4, 2022.
(60) Provisional application No. 63/193,653, filed on May 27, 2021.

(51) Int. Cl. B01D 27/08; B01D 29/15

(52) U.S. Cl. CPC B01D 27/08; B01D 29/15; B01D 2201/304; B01D 2201/305

(57) ABSTRACT

A filter cartridge that includes a canister configured to hold a filter element. The canister has a canister body with an open end and an end closure. The end closure has a central annular element locating feature, and an annular frame portion circumscribing the central annular element locating feature. The canister body and end closure have cooperating geometry for retaining the end closure to the open end of the canister. The cooperating geometry includes an axial retention mechanism for maintaining an attachment between the canister and the end closure. The axial retention mechanism is configured to maintain the attachment solely via mechanical interference.

### CROSS-REFERENCE TO RELATED PATENT APPLICATION

This patent application is a continuation of co-pending International Application No. PCT/US2022/027884, filed May 5, 2022, which designates the United States, and which is now pending. The entire teachings and disclosure of International Application No. PCT/US2022/027884 are incorporated herein by reference thereto. International Application No. PCT/US2022/027884 claims the benefit of U.S. Provisional Application No. 63/306,746, filed on Feb. 4, 2022, and claims the benefit of U.S. Provisional Patent Application No. 63/193,653, filed May 27, 2021, the entire teachings and disclosure of which are incorporated herein by reference thereto.

### FIELD OF THE INVENTION

This invention generally relates to a diesel fuel replacement filter.

### BACKGROUND OF THE INVENTION

Conventional fuel filters are often made using plastic components that are spin-welded to join particular plastic components, such as the base plate and canister, for example. However, spin welding plastic components has proven problematic for a variety of reasons. The spin welding process typically requires complex equipment set up and operation, challenging weld joint geometries, and can be made more difficult by variations in the raw materials. All of these issues may lead to delays in production and/or expensive and time-consuming product failures during development and manufacturing. Therefore, it would be advantageous to have a method of assembly for such fuel filters that does not include spin welding. Such a method would provide significant benefit by eliminating failures and the delays and associated costs that come with the spin welding process.

Embodiments of the invention detailed below represent an improvement to the state of the art with respect to hydraulic filtration devices. These and other advantages of the invention, as well as additional inventive features, will be apparent from the description of the invention provided herein.

### BRIEF SUMMARY OF THE INVENTION

Embodiments of the present invention address some of the concerns set forth above by disclosing a fuel filter replacement, such as might be used in a diesel engine for example, where the fuel filter does not require spin welding to join to pressure critical plastic components, as in conventional fuel filters.

In a certain embodiment of the invention, a filter cartridge includes a canister configured to hold a filter element. The canister has a canister body with an open end and an end closure. The end closure has a central annular element locating feature, and an annular frame portion circumscribing the central annular element locating feature. The canister body and end closure have cooperating geometry for retaining the end closure to the open end of the canister. The cooperating geometry includes an axial retention mechanism for maintaining an attachment between the canister and the end closure. The axial retention mechanism is configured to maintain the attachment solely via mechanical interference.

In some embodiments, the axial retention mechanism includes an internal annular rib circumscribing an inner surface of the canister, proximate the open end, and an external annular rib circumscribing an outer surface of the flexible portion of the end closure. The external annular rib of the flexible portion of the end closure is configured and arranged to engage the internal annular rib of the canister when the end closure is attached to the open end of the canister. The internal annular rib may extend continuously around the inner surface of the canister. In particular embodiments, the internal annular rib has an average height of five hundredths of an inch with respect to the inner surface of the canister.

In a further embodiment, the external annular rib extends continuously around the outer surface of the flexible portion of the end closure. In more particular embodiments, the external annular rib has an average height of ten hundredths of an inch with respect to the outer surface of the flexible portion of the end closure. In other embodiments, the mechanical interference between the external annular rib and the internal annular rib is at least three hundredths of an inch. As specified in this application, the dimension associated with mechanical interference refers to the distance that one component extends past the closest point of a second component. Thus, the aforementioned embodiment indicates that the external annular rib extends at least three hundredths of an inch beyond the closed part of the internal annular rib and vice versa.

In another embodiment of the invention, an axial end of the flexible portion of the end closure is chamfered to facilitate insertion of the end closure into the canister body. In some embodiments, the end closure includes a groove that extends around a circumference of an outer perimeter surface of the annular frame portion, where the groove is configured to seat an O-ring.

In an alternate embodiment, the axial retention mechanism includes an internal annular rib circumscribing an inner surface of the canister, proximate the open end, and a plurality of flexible tabs spaced around a perimeter edge section of the frame portion. The flexible tabs on the perimeter edge section of the frame portion project in a direction axially inwardly into the canister and are configured and arranged to engage the internal annular rib of the canister when the end closure is attached to the open end of the canister. The flexible tabs may be evenly spaced around the perimeter edge section of the frame portion. Additionally, the flexible tabs may each have a radially outward facing snap tab portion. The filter cartridge may further include a series of axial ribs on the inner surface of the canister extending toward the open end of the canister at least as far as the internal annular rib, where the flexible tabs are arranged to fit between the axial ribs when the end closure is attached to the canister in order to prevent rotation of the end closure relative to the canister body. In some particular embodiments, the internal annular rib has an average height of ten hundredths of an inch with respect to the inner surface of the canister.

In certain particular embodiments, the axial retention mechanism includes a series of axial ribs on an inner surface of the canister, each of which has a shoulder at a distal end of each rib proximate the open end of the canister, and a plurality of flexible tabs spaced around a perimeter edge section of the frame portion. The flexible tabs on the perimeter edge section of the frame portion may project in a direction axially inwardly into the canister, and may be configured and arranged to engage the shoulder of the axial ribs on the canister when the end closure is attached to the open end of the canister. In a more particular embodiment, the plurality of flexible tabs is evenly spaced around the perimeter edge section of the frame portion, and the series of axial ribs is evenly spaced around the inner surface of the canister such that each flexible tab is engaged with a respective axial rib when the end closure is attached to the open end of the canister.

In a further embodiment, each flexible tab includes a slotted portion in which the respective axial rib is seated, wherein the seating of the flexible tab in the slotted portion acts to prevent rotation of the end closure relative to the canister. Additionally, the flexible tabs may each have a radially outward facing snap tab portion, such that the mechanical interference between the outward facing snap tab portion and the shoulder provides axial retention. In more particular embodiments, the mechanical interference between the radially outward facing snap tab portion and the shoulder is at least three hundredths of an inch. The end closure may include a first groove that extends around a circumference of an outer perimeter surface of the annular frame portion, the first groove being configured to seat an O-ring. Furthermore, the canister may include a second groove around a circumference of the inner surface located proximate the first groove when the end closure is attached to the open end of the canister, where the second groove is configured to seat the O-ring.

In yet another embodiment of the invention, the cooperating geometry further includes an anti-rotation mechanism for preventing rotation of the base plate relative to the canister, the anti-rotation mechanism configured to prevent rotation of the base plate relative to the canister solely via mechanical interference. In a particular embodiment, the anti-rotation mechanism has a plurality of axial locating slots and axial locating tabs spaced apart around a perimeter edge section of the frame portion and an outer edge of the open end of the canister. The axial locating tabs and axial locating slots may be configured and arranged to interengage to rotationally align the end closure and the canister when the end closure is attached to the open end of the canister. In some embodiments, the end closure further includes a plurality of radial support ribs projecting between the element locating feature and the rigid attachment portion of the frame portion.

In an alternate embodiment, the anti-rotation mechanism has a plurality of radially-inward projecting tabs spaced apart around the circumference of the interior surface of the canister, and a plurality of radially-inward projecting slots spaced around a perimeter surface of an annular frame portion of the end closure. The engagement between each of the plurality radially-inward projecting tabs and a respective radially-inward projecting slot prevents rotation of the end closure relative to the canister.

In one aspect, embodiments of the invention provide a filter cartridge including a filter element located within a canister. The canister includes a canister body with an open end and an end closure. The end closure has a central annular element locating feature. The end closure further includes an annular frame portion circumscribing the element locating feature with an annular rigid attachment portion and an annular flexible portion projecting from the rigid attachment portion. The end closure also includes radial support ribs projecting between the element locating feature and the rigid attachment portion of the frame portion. The flexible portion is unconstrained by the radial support ribs. The canister body and end closure having cooperating geometry retaining the end closure to the open end of the canister. The cooperating geometry includes an internal annular rib circumscribing an inner surface of the canister, proximate the open end, and an external annular rib circumscribing an outer surface of the flexible portion of the end closure. The external annular rib of the flexible portion of the end closure is configured and arranged to engage the internal annular rib of the canister when the end closure is attached to the open end of the canister.

In a particular embodiment, the internal annular rib extends continuously around the inner surface of the canister. In other embodiments, the external annular rib extends continuously around the outer surface of the flexible portion of the end closure.

In another aspect, embodiments of the invention provide a filter cartridge including a filter element located within a canister. The canister includes a canister body with an open end and an end closure. The end closure has a central annular element locating feature, and an annular frame portion circumscribing the element locating feature. The end closure also has radial support ribs projecting between the element locating feature and the rigid attachment portion of the frame portion. The canister body and end closure have cooperating geometry retaining the end closure to the open end of the canister. The cooperating geometry includes an internal annular rib circumscribing an inner surface of the canister, proximate the open end. The cooperating geometry further includes a plurality of flexible tabs spaced around a perimeter edge section of the frame portion. The flexible tabs on the perimeter edge section of the frame portion project in a direction axially inwardly into the canister, and are configured and arranged to engage the internal annular rib of the canister when the end closure is attached to the open end of the canister.

In a certain embodiment, the flexible tabs are evenly spaced around the perimeter edge section of the frame portion. Additionally, the flexible tabs may each have a radially outward facing snap tab portion. The filter cartridge may also include a series of axial ribs on the inner surface of the canister terminating proximate the open end of the canister, where the flexible tabs are arranged to fit between the axial ribs when the end closure is attached to the canister.

In yet another aspect, embodiments of the invention provide a filter cartridge including a filter element located within a canister. The canister includes a canister body with an open end and an end closure. The end closure has a central annular element locating feature, and an annular frame portion circumscribing the element locating feature The end closure further includes radial support ribs projecting between the element locating feature and the rigid attachment portion of the frame portion. The canister body and end closure have cooperating geometry retaining the end closure to the open end of the canister. The cooperating geometry includes an internal annular rib circumscribing an inner surface of the canister, proximate the open end and an external annular rib circumscribing an outer surface of the end closure. The external annular rib of the end closure is configured and arranged to engage the internal annular rib of the canister when the end closure is attached to the open end of the canister. The cooperating geometry also includes a plurality of axial locating slots and axial locating tabs spaced apart around a perimeter edge section of the frame portion and an outer edge of the open end of the canister. The axial locating tabs and axial locating slots are configured and arranged to interengage to rotationally align the end closure and the canister when the end closure is attached to the open end of the canister.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of a filter cartridge, constructed in accordance with an embodiment of the invention;

FIG. 2. is a perspective view of an end closure for a filter cartridge, constructed in accordance with an embodiment of the invention;

FIG. 3 is a cross-sectional view of a canister for a filter cartridge along with a close-up cross-sectional view of the end closure of FIG. 1 attached to a canister, in accordance with an embodiment of the invention;

FIG. 4 is a cross-sectional view of the end closure, according to an embodiment of the invention;

FIG. 5 is a perspective view of an end closure for a filter cartridge, constructed in accordance with an embodiment of the invention different from that of FIG. 1;

FIG. 6 is a cross-sectional view of a canister for a filter cartridge along with a close-up cross-sectional view of the end closure of FIG. 5 attached to a canister, according to an embodiment of the invention;

FIG. 7 is a perspective view of an end closure for a filter cartridge, constructed in accordance with an embodiment of the invention different from that of FIGS. 1 and 5;

FIG. 8 is an enlarged cross-sectional view of the end closure of FIG. 7 attached to a canister, according to an embodiment of the invention;

FIG. 9 is an enlarged perspective view of an interior portion of the canister, according to an embodiment of the invention;

FIG. 10 is an enlarged cross-sectional view of the end closure and canister showing an O-ring groove, in accordance with an embodiment of the invention;

FIG. 11 is a perspective side view of an end closure with radial splines, constructed in accordance with an embodiment of the invention;

FIG. 12 is an enlarged perspective view of the end closure of FIG. 11 showing a radial spline;

FIG. 13 is an enlarged view of a portion of the canister showing a mating notch to accommodate the radial spline of FIG. 12, according to an embodiment of the invention;

FIG. 14 is a perspective view of a portion of the end closure of FIG. 11 attached to a filter cartridge canister, in accordance with an embodiment of the invention;

FIG. 15 is a perspective view of an end closure/canister assembly, according to an embodiment of the invention; and

FIG. 16 is an enlarged view of the radially inward-projection slot on the end closure, in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

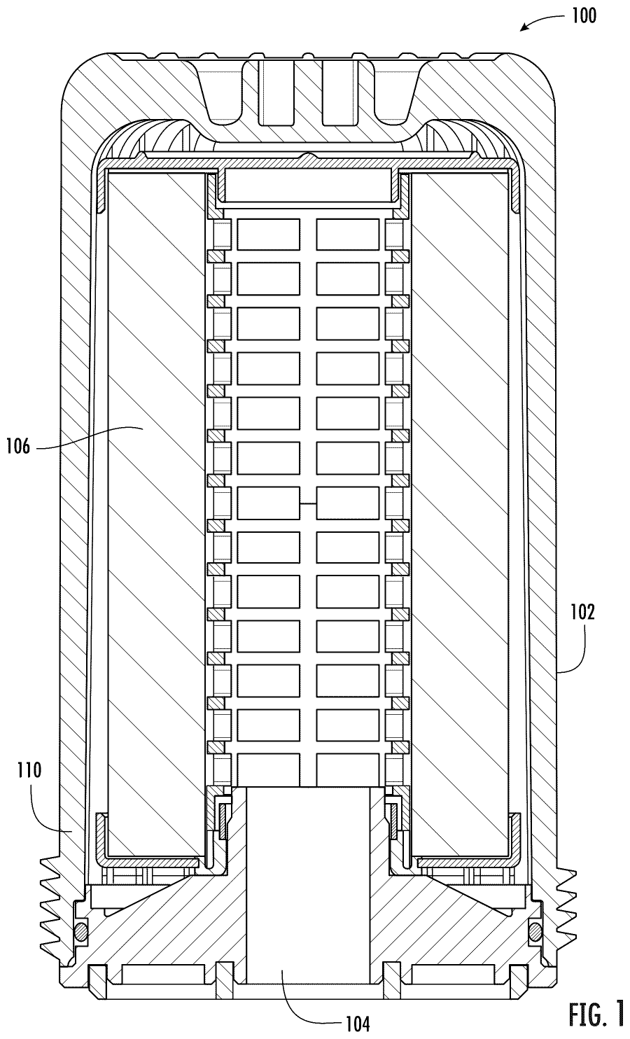

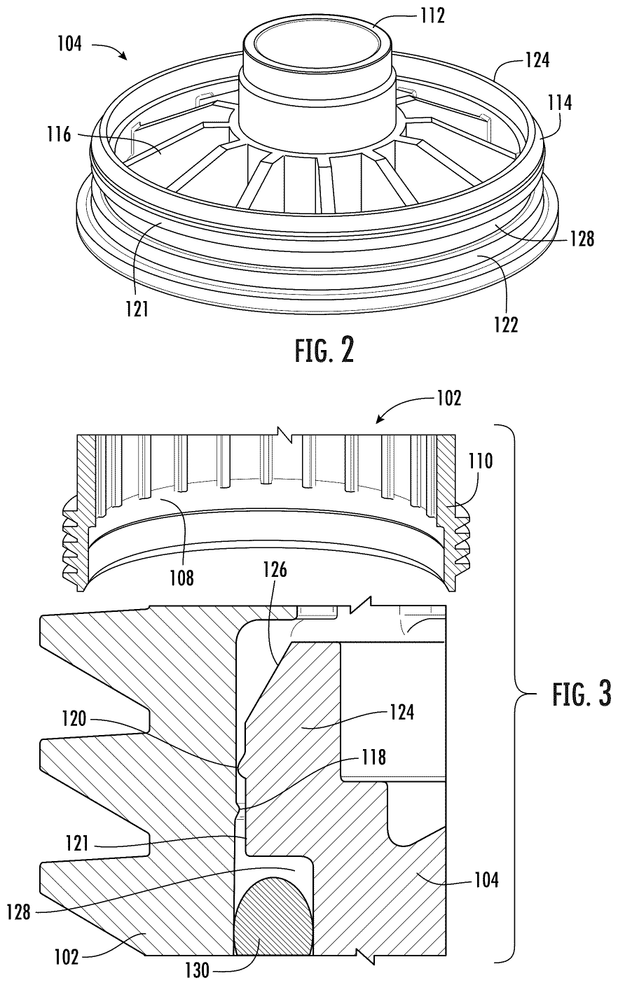

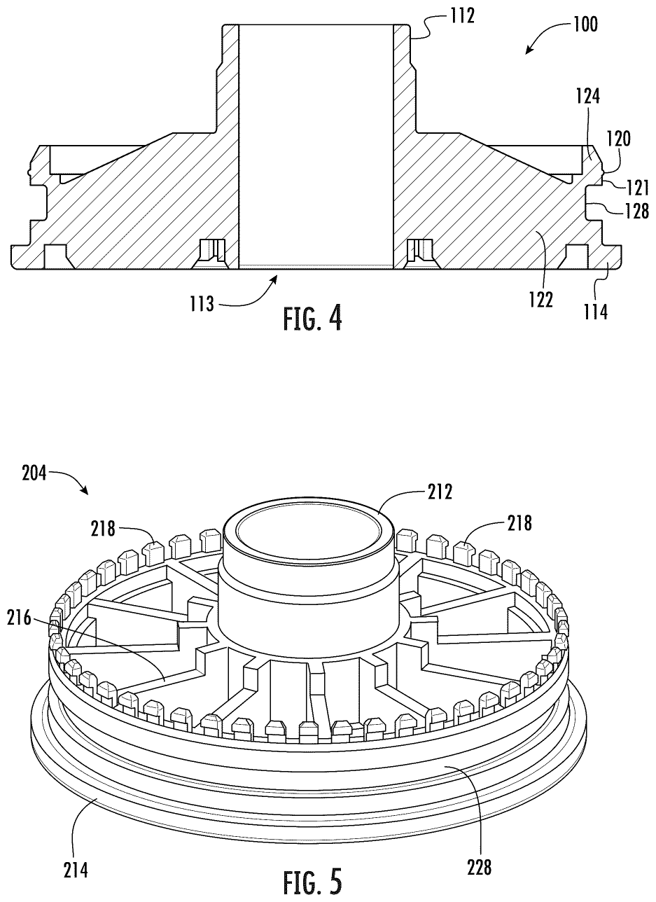

FIG. 1 is a cross-sectional view of a filter cartridge 100, constructed in accordance with an embodiment of the invention. The filter cartridge 100 includes a canister 102 and a base plate which is referred to herein as an end closure 104. The base plate or end closure is typically attached to the canister to hold the filter element in place. In the embodiment shown, the canister 102 is configured to hold a filter element 106 when the end closure 104 is attached to the canister 102. FIG. 2 shows a perspective view of the end closure 104 for the filter cartridge 100, constructed in accordance with an embodiment of the invention. FIG. 3 shows a perspective view of a cross-section for an end portion of the canister 102 for the filter cartridge 100 showing an inner surface 108 of the canister 102, along with an enlarged cross-section of the end closure 104 of FIG. 1 attached to the canister 102. FIG. 4 is a cross-sectional view of the end closure 104, according to an embodiment of the invention.

In certain embodiments of the invention, the canister 102 has a canister body 110 with an open end in which the end closure 104 is inserted to attach to the canister 102. The end closure 104 has a central annular element locating feature 112 that defines a central opening 113, and an annular frame portion 114 circumscribing the central annular element locating feature 112. In a more particular embodiment, the annular frame portion 114 circumscribing the element locating feature 112 includes an annular rigid attachment portion 122 and an annular flexible portion 124 projecting from the rigid attachment portion 122. In embodiments of the invention, the end closure 104 is made from a resilient material such as plastic. As such, because it is not stiffened by support ribs 116, the flexible portion 124 is able to move slightly during assembly of the end closure 104 to the canister 102.

In the embodiment shown, the end closure 104 includes a plurality of radial support ribs 116 projecting between the element locating feature 112 and the annular frame portion 114 to support and connect the central annular element locating feature 112 and annular frame portion 114. In alternate embodiments, the element locating feature 112 and annular frame portion 114 may be connected by spokes, a solid flat plate, an angled flat plate, or a wedge-shaped plate.

In certain embodiments, the canister body 110 and end closure 104 have cooperating geometry for retaining the end closure 104 to the open end of the canister 102. The cooperating geometry may include an axial retention mechanism for maintaining an attachment between the canister 102 and the end closure 104. In the embodiments shown, the axial retention mechanism is configured to maintain the aforementioned attachment solely via mechanical interference.

In some embodiments, the axial retention mechanism includes an internal annular rib 118 circumscribing an inner surface 108 of the canister 102, proximate the open end, and an external annular rib 120 circumscribing an outer surface 121 of the flexible portion 124 of the end closure. The external annular rib 120 of the flexible portion 124 of the end closure 104 is configured and arranged to engage the internal annular rib 118 of the canister 102 when the end closure 104 is attached to the open end of the canister 102. The internal annular rib 118 may extend continuously around the inner surface 108 of the canister 102. In particular embodiments, the internal annular rib 118 has an average height of five hundredths of an inch with respect to the inner surface 108 of the canister 102.

In a further embodiment, the external annular rib 120 extends continuously around the outer surface 121 of the flexible portion 124 of the end closure 104. In more particular embodiments, the external annular rib 120 has an average height of ten hundredths of an inch with respect to the outer surface 121 of the flexible portion 124 of the end closure 104. In other embodiments, the mechanical interference between the external annular rib 120 and the internal annular rib 118 is at least three hundredths of an inch. As specified in this application, the dimension associated with mechanical interference refers to the distance that one component extends past the closest point of a second component. Thus, the aforementioned embodiment indicates that the external annular rib 120 extends at least three hundredths of an inch beyond the closed part of the internal annular rib 118 and vice versa.

In another embodiment of the invention, an axial end 126 of the flexible portion 124 of the end closure 104 is chamfered to facilitate insertion of the end closure 104 into the canister body 110. In some embodiments, the end closure 104 includes a groove 128 that extends around a circumference of the outer perimeter surface of the annular rigid attachment portion 122, where the groove 128 is configured to seat an O-ring 130.

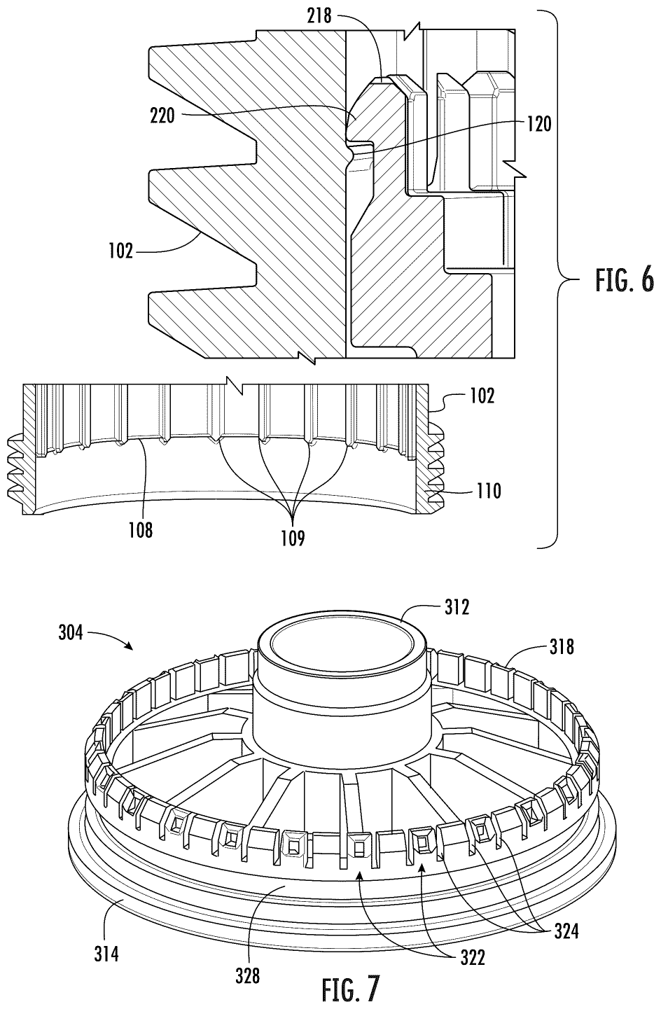

FIG. 5 is a perspective view of a different embodiment of an end closure 204 for the filter cartridge 100, constructed in accordance with an embodiment of the invention different from that of FIG. 1. FIG. 6 is a cross-sectional view of the canister 102 for filter cartridge 100 along with a close-up cross-sectional view of the end closure 204 of FIG. 5 attached to the canister 102, according to an embodiment of the invention.

Like the end closure 104 of FIGS. 1-4, the end closure 204 of FIGS. 5-6 has a central annular element locating feature 212 that defines a central opening, and an annular frame portion 214 circumscribing the central annular element locating feature 212. In embodiments of the invention, the end closure 204 is made from a resilient material such as plastic. In the embodiment shown, the end closure 204 includes a plurality of radial support ribs 216 projecting between the element locating feature 212 and the annular frame portion 214 to support and connect the central annular element locating feature 212 and annular frame portion 214. In alternate embodiments, the element locating feature 212 and annular frame portion 214 may be connected by spokes, a solid flat plate, an angled flat plate, or a wedge-shaped plate. Additionally, the end closure 204 may include a groove 228 that extends around a circumference of an outer perimeter surface of the annular frame portion 214, with the groove 228 being configured to seat the O-ring 130 (shown in FIG. 3).

In this embodiment, the axial retention mechanism includes the internal annular rib 120 circumscribing the inner surface 108 of the canister 102 proximate the open end, and a plurality of flexible tabs 218 spaced around a perimeter edge section of the frame portion 214. The flexible tabs 218 on the perimeter edge section of the frame portion 214 project in a direction axially inwardly into the canister 102 and are configured and arranged to engage the internal annular rib 120 of the canister 102 when the end closure 104 is attached to the open end of the canister 102. The flexible tabs 218 may be evenly spaced around the perimeter edge section of the frame portion 214. Additionally, the flexible tabs 218 may each have a radially outward facing snap tab portion 220. Additionally, the outward facing snap tab portion 220 may be chamfered to facilitate insertion of the end closure 204 into the canister body 110.

The filter canister 102 may further include a series of axial ribs 109 on the inner surface 108 of the canister 102 extending toward the open end of the canister 102 at least as far as the internal annular rib 120, where the flexible tabs 218 are arranged to fit between the axial ribs 109 when the end closure 204 is attached to the canister 102 in order to prevent rotation of the end closure 102 relative to the canister body 110. During insertion of the end closure 204 into the canister 102, the flexible tabs 218 flex radially inward as the radially outward facing snap tab portion 220 engages the internal annular rib 120. As the radially outward facing snap tab portion 220 moves past the internal annular rib 120, the flexible tab 218 flexes back to its normal position. The mechanical interference between the snap tab portion 220 and the internal annular rib 120 provide axial retention between the end closure 204 and the canister 102. In some particular embodiments, the internal annular rib 120 has an average height of ten hundredths of an inch with respect to the inner surface 108 of the canister 102.

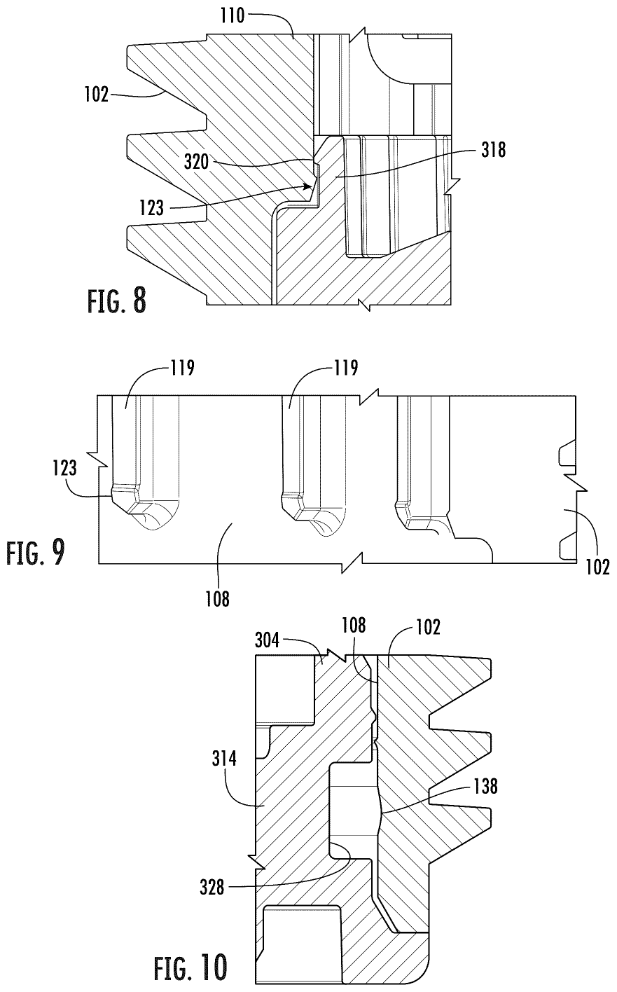

FIG. 7 is a perspective view of yet another end closure 304 for the filter cartridge 100, constructed in accordance with an embodiment of the invention different from that of FIGS. 1 and 4. FIG. 8 is an enlarged cross-sectional view of the end closure 304 of FIG. 7 shown attached to the canister 102, according to an embodiment of the invention. FIG. 9 is an enlarged perspective view of an interior portion of the canister 102, according to an embodiment of the invention.

Like the end closures 104, 204 described above, the end closure 304 of FIGS. 5-6 has a central annular element locating feature 312 that defines a central opening, and an annular frame portion 314 circumscribing the central annular element locating feature 312. In embodiments of the invention, the end closure 304 is made from a resilient material such as plastic. In the embodiment shown, the end closure 304 includes a plurality of radial support ribs 316 projecting between the element locating feature 312 and the annular frame portion 314 to support and connect the central annular element locating feature 312 and annular frame portion 314. In alternate embodiments, the element locating feature 312 and annular frame portion 314 may be connected by spokes, a solid flat plate, an angled flat plate, or a wedge-shaped plate.

In this embodiment, the axial retention mechanism includes a series of axial ribs 119 on an inner surface 108 of the canister 102, each of which has a shoulder 123 at a distal end of each rib 119 proximate the open end of the canister 102, and a plurality of flexible tabs 318 spaced around a perimeter edge section of the frame portion 314. The flexible tabs 318 on the perimeter edge section of the frame portion 314 may project in a direction radially inwardly into the canister 102, and may be configured and arranged to engage the shoulder 123 of the axial ribs 119 on the canister 102 when the end closure 304 is attached to the open end of the canister 102.

In a more particular embodiment, the plurality of flexible tabs 318 is evenly spaced around the perimeter edge section of the frame portion 314, and the series of axial ribs 119 is evenly spaced around the inner surface 108 of the canister 102 such that each flexible tab 318 is engaged with a respective axial rib 119 when the end closure 304 is attached to the open end of the canister 102. During insertion of the end closure 304 into the canister 102, the flexible tabs 318 flex radially inward as the radially outward facing snap tab portion 320 engages the shoulder 123. As the radially outward facing snap tab portion 320 moves past the shoulder 123, the flexible tab 318 flexes back to its normal position.

In a further embodiment, each flexible tab 318 includes a slotted portion 322 in which the respective axial rib 119 is seated. The slotted portion 322 has edge members 324 positioned on each side of the axial rib 119 when the rib 119 is seated in the slotted portion 322. The seating of the flexible tab 318 in the slotted portion acts to prevent rotation of the end closure 304 relative to the canister 102. Additionally, the flexible tabs 318 may each have a radially outward facing snap tab portion 320, such that the mechanical interference between the outward facing snap tab portion 320 and the shoulder 123 provides the axial retention. In more particular embodiments, the mechanical interference between the radially outward facing snap tab portion 320 and the shoulder 123 is at least three hundredths of an inch.

As used in this application, the dimension associated with mechanical interference refers to the distance that one component extends past the closest point of a second component. Thus, the preceding exemplary embodiment is one in which the radially outward facing snap tab portion 320 extends at least three hundredths of an inch beyond the closed part of the shoulder 123 and vice versa. In a particular embodiment, the outward facing snap tab portion 320 is chamfered to facilitate insertion of the end closure 304 into the canister body 110.

The end closure 304 may include a first groove 328 that extends around a circumference of an outer perimeter surface of the annular frame portion 314, the first groove 328 being configured to seat the O-ring 130. FIG. 10 shows a close-up cross-sectional view of the first groove 328 of the end closure 304 attached to the canister 102. The O-ring 130 is omitted from this view to make it easier to see the features of the end closure 304 and canister 102. In this embodiment, the canister 102 may include a second groove 138 that extends around a circumference of the inner surface 108 located proximate the first groove 328 when the end closure 304 is attached to the open end of the canister 102, where the second groove 138 is also configured to seat the O-ring 130 (shown in FIG. 3). Compression of the O-ring 130 in the first groove 328 and second groove 138, when the end closure 304 is attached to the canister 102, aids in the axial retention and in preventing rotation of the end closure 304 with respect to the canister 102.

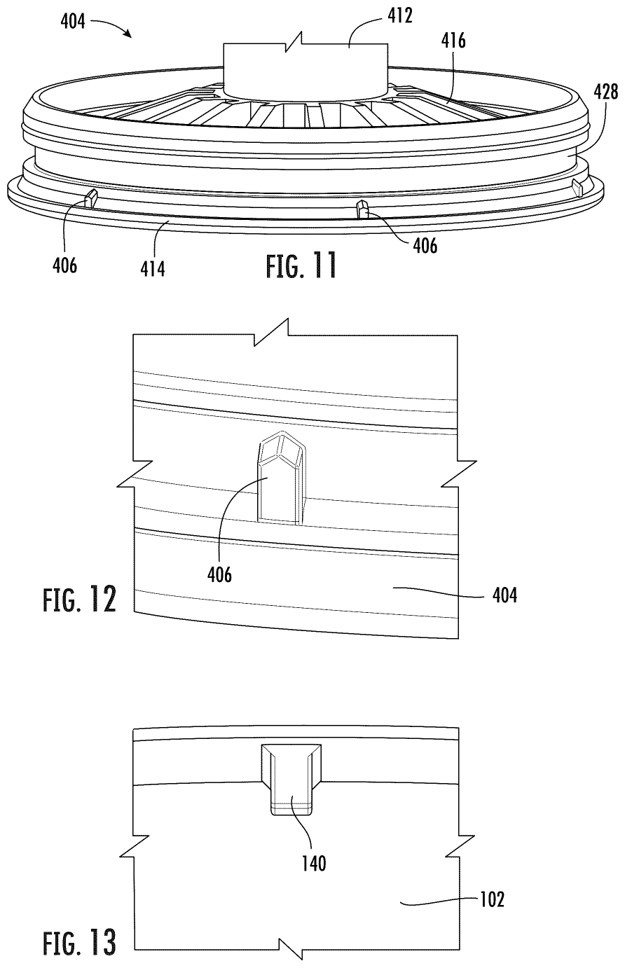

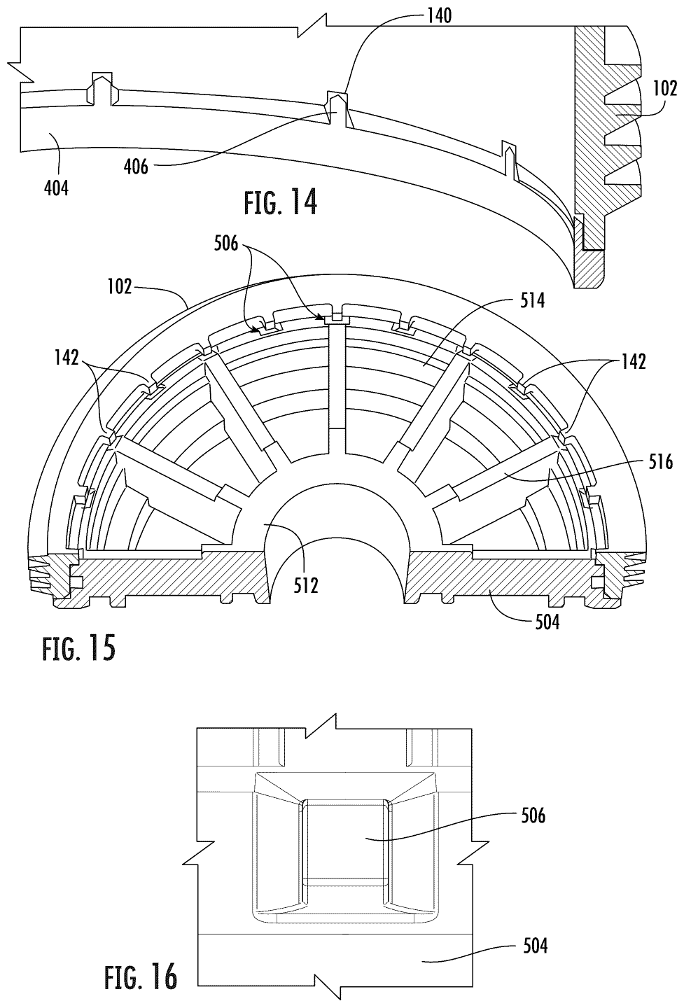

FIG. 11 is a perspective side view of an end closure 404 with radial splines 406, constructed in accordance with an embodiment of the invention, while FIG. 12 shows an enlarged perspective view of the end closure 404 and of a radial spline 406. FIG. 13 is an enlarged view of a portion of the canister 102 showing a mating notch 140 to accommodate the radial spline 406 of FIG. 12, in accordance with an embodiment of the invention. FIG. 14 is a perspective view of a portion of the end closure 404 attached to a filter cartridge canister 102, in accordance with an embodiment of the invention. For the sake of clarity, FIG. 14 only shows the portion of the end closure 404 with the radial spline 406 and the portion of the canister 102 with the mating notches 140 that engage the radial splines 406.

Like the end closures 104, 204, 304 described above, the end closure 404 of FIGS. 11-12 has a central annular element locating feature 412 that defines a central opening, and an annular frame portion 414 circumscribing the central annular element locating feature 412. In embodiments of the invention, the end closure 404 is made from a resilient material such as plastic. In the embodiment shown, the end closure 404 includes a plurality of radial support ribs 416 projecting between the element locating feature 412 and the annular frame portion 414 to support and connect the central annular element locating feature 412 and annular frame portion 414. In alternate embodiments, the element locating feature 412 and annular frame portion 414 may be connected by spokes, a solid flat plate, an angled flat plate, or a wedge-shaped plate.

In this embodiment, the cooperating geometry of the end closure 404 and canister 102 as described above, constitutes an anti-rotation mechanism for preventing rotation of the end closure 404 relative to the canister 102. Further, this anti-rotation mechanism is configured to prevent rotation of the end closure 404 relative to the canister 102 solely via mechanical interference. As shown in FIGS. 11-14, the end closure 404 has a plurality of axially-extending (and radially-extending) radial splines 406, which function as locating tabs, spaced apart around a perimeter edge section of the frame portion 414. The radial splines 406 may be evenly spaced around the entire circumference of the annular frame portion 414 though embodiments with uneven spacing of radial splines 406 is envisioned. Additionally, the end closure 404 may include a groove 428 that extends around a circumference of an outer perimeter surface of the annular frame portion 414, the groove 428 being configured to seat the O-ring 130 (shown in FIG. 3).

The canister 102 includes a plurality of mating notches 140 which are shown as axially-extending locating slots spaced apart around an outer edge of the open end of the canister 102. The radial splines 406 and mating notches 140 may be configured and arranged to interengage to rotationally align the end closure 404 and the canister 102 when the end closure 404 is attached to the open end of the canister 102.

Another anti-rotation mechanism is shown in FIGS. 15 and 16. In this embodiment, the canister 102 includes a plurality of radially-inward projecting tabs 142 spaced apart around the circumference of the interior surface 108 of the canister 102. The radially-inward projecting tabs 142 are designed the engage a plurality of radially-inward projecting slots 506 spaced around a perimeter surface of an annular frame portion 514 of the end closure 504. When the end closure 504 is assembled to the canister 102, each of the radially-inward projecting tabs 142 seats with a radially-inward projecting slot 506. This engagement between radially-inward projecting tabs 142 and radially-inward projecting slot 506 prevents rotation of the end closure 504 relative to the canister 102.

Like the end closures 104, 204, 304, 404 described above, the end closure 504 of FIG. 15 has a central annular element locating feature 512 that defines a central opening, and an annular frame portion 514 circumscribing the central annular element locating feature 512. In embodiments of the invention, the end closure 504 is made from a resilient material such as plastic. In the embodiment shown, the end closure 504 includes a plurality of radial support ribs 416 projecting between the element locating feature 412 and the annular frame portion 514 to support and connect the central annular element locating feature 512 and annular frame portion 514.

The foregoing description discloses exemplary embodiments of a fuel filter with external housing components that are assembled via mechanical interference connection. For an all-plastic spin-on filter, the base plate or end closure could be threaded into the filter canister or these two components could be spin welded to form the necessary attachment. Threading is very time-consuming as the parts must be aligned, as it takes a fair amount of time to run the threads together. As explained above, spin welding has certain shortcomings as well. Assembling the components by relying on mechanical interference to maintain the attachment is a faster alternative to threading without all the complications that come with spin welding.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter cartridge comprising:
a canister configured to hold a filter element, the canister having a canister body with an open end and an end closure, the end closure having:
a central annular element locating feature; and
an annular frame portion circumscribing the central annular element locating feature;
wherein the canister body and end closure have cooperating geometry for retaining the end closure to the open end of the canister, the cooperating geometry including:
an axial retention mechanism for maintaining an attachment between the canister and the end closure, the axial retention mechanism configured to maintain the attachment solely via mechanical interference.

2. The filter cartridge of claim 1, wherein the axial retention mechanism comprises:
an internal annular rib circumscribing an inner surface of the canister, proximate the open end; and
an external annular rib circumscribing an outer surface of the flexible portion of the end closure, the external annular rib of the flexible portion of the end closure configured and arranged to engage the internal annular rib of the canister when the end closure is attached to the open end of the canister.

3. The filter cartridge of claim 2, wherein the internal annular rib extends continuously around the inner surface of the canister.

4. The filter cartridge of claim 3, wherein the internal annular rib has an average height of five hundredths of an inch with respect to the inner surface of the canister.

5. The filter cartridge of claim 2, wherein the external annular rib extends continuously around the outer surface of the flexible portion of the end closure.

6. The filter cartridge of claim 5, wherein the external annular rib has an average height of ten hundredths of an inch with respect to the outer surface of the flexible portion of the end closure.

7. The filter cartridge of claim 2, wherein the mechanical interference between the external annular rib and the internal annular rib is at least three hundredths of an inch.

8. The filter cartridge of claim 2, wherein an axial end of the flexible portion of the end closure is chamfered to facilitate insertion of the end closure into the canister body.

9. The filter cartridge of claim 2, wherein the end closure includes a groove that extends around a circumference of an outer perimeter surface of the annular frame portion, the groove configured to seat an O-ring.

10. The filter cartridge of claim 1, wherein the axial retention mechanism comprises:
an internal annular rib circumscribing an inner surface of the canister, proximate the open end; and
a plurality of flexible tabs spaced around a perimeter edge section of the frame portion, the flexible tabs on the perimeter edge section of the frame portion projecting in a direction axially inwardly into the canister and configured and arranged to engage the internal annular rib of the canister when the end closure is attached to the open end of the canister.

11. The filter cartridge of claim 10, wherein the flexible tabs are evenly spaced around the perimeter edge section of the frame portion.

12. The filter cartridge of claim 10, wherein the flexible tabs each have a radially outward facing snap tab portion.

13. The filter cartridge of claim 10, further including a series of axial ribs on the inner surface of the canister extending toward the open end of the canister at least as far as the internal annular rib, the flexible tabs arranged to fit between the axial ribs when the end closure is attached to the canister to prevent rotation of the end closure relative to the canister body.

14. The filter cartridge of claim 10, wherein the internal annular rib has an average height of ten hundredths of an inch with respect to the inner surface of the canister.

15. The filter cartridge of claim 1, wherein the axial retention mechanism comprises:
a series of axial ribs on an inner surface of the canister, each of which has a shoulder at a distal end of each rib proximate the open end of the canister; and
a plurality of flexible tabs spaced around a perimeter edge section of the frame portion, the flexible tabs on the perimeter edge section of the frame portion projecting in a direction axially inwardly into the canister and configured and arranged to engage the shoulder of the axial ribs on the canister when the end closure is attached to the open end of the canister.

16. The filter cartridge of claim 15, wherein the plurality of flexible tabs is evenly spaced around the perimeter edge section of the frame portion, and the series of axial ribs is evenly spaced around the inner surface of the canister such that each flexible tab is engaged with a respective axial rib when the end closure is attached to the open end of the canister.

17. The filter cartridge of claim 16, wherein each flexible tab includes a slotted portion in which the respective axial rib is seated, wherein the seating of the flexible tab in the slotted portion acts to prevent rotation of the end closure relative to the canister.

18. The filter cartridge of claim 15, wherein the flexible tabs each have a radially outward facing snap tab portion, wherein the mechanical interference between the outward facing snap tab portion and the shoulder provides axial retention.

19. The filter cartridge of claim 18, wherein the mechanical interference between the radially outward facing snap tab portion and the shoulder is at least three hundredths of an inch.

20. The filter cartridge of claim 15, wherein the end closure includes a first groove that extends around a circumference of an outer perimeter surface of the annular frame portion, the groove configured to seat an O-ring.

21. The filter cartridge of claim 20, wherein the canister includes a second groove around a circumference of the inner surface located proximate the first groove when the end closure is attached to the open end of the canister, the second groove configured to seat the O-ring.

22. The filter cartridge of claim 1, wherein the cooperating geometry further includes an anti-rotation mechanism for preventing rotation of the base plate relative to the canister, the anti-rotation mechanism configured to prevent rotation of the base plate relative to the canister solely via mechanical interference.

23. The filter cartridge of claim 22, wherein the anti-rotation mechanism comprises:
a plurality of axial locating slots and axial locating tabs spaced apart around a perimeter edge section of the frame portion and an outer edge of the open end of the canister, the axial locating tabs and axial locating slots configured and arranged to interengage to rotationally align the end closure and the canister when the end closure is attached to the open end of the canister.

24. The filter cartridge of claim 22, wherein the anti-rotation mechanism comprises:
a plurality of radially-inward projecting tabs spaced apart around the circumference of the interior surface of the canister; and
a plurality of radially-inward projecting slots spaced around a perimeter surface of an annular frame portion of the end closure;
wherein engagement between each of the plurality radially-inward projecting tabs and a respective radially-inward projecting slot prevents rotation of the end closure relative to the canister.

25. The filter cartridge of claim 1, wherein the end closure further includes a plurality of radial support ribs projecting between the element locating feature and the rigid attachment portion of the frame portion.

26. A filter cartridge comprising:
a filter element located within a canister, wherein the canister includes a canister body with an open end and an end closure, the end closure having:
a central annular element locating feature;
an annular frame portion circumscribing the element locating feature including an annular rigid attachment portion and an annular flexible portion projecting from the rigid attachment portion; and
radial support ribs projecting between the element locating feature and the rigid attachment portion of the frame portion, wherein the flexible portion is unconstrained by the radial support ribs, the canister body and end closure having cooperating geometry retaining the end closure to the open end of the canister, the cooperating geometry including:
an internal annular rib circumscribing an inner surface of the canister, proximate the open end; and
an external annular rib circumscribing an outer surface of the flexible portion of the end closure, the external annular rib of the flexible portion of the end closure configured and arranged to engage the internal annular rib of the canister when the end closure is attached to the open end of the canister.

27. The filter cartridge as in claim 26, wherein the internal annular rib extends continuously around the inner surface of the canister.

28. The filter cartridge as in claim 26, wherein the external annular rib extends continuously around the outer surface of the flexible portion of the end closure.

29. A filter cartridge comprising:
a filter element located within a canister, wherein the canister includes a canister body with an open end and an end closure, the end closure having:
a central annular element locating feature;
an annular frame portion circumscribing the element locating feature; and
radial support ribs projecting between the element locating feature and the rigid attachment portion of the frame portion, the canister body and end closure having cooperating geometry retaining the end closure to the open end of the canister, the cooperating geometry including:
an internal annular rib circumscribing an inner surface of the canister, proximate the open end; and
a plurality of flexible tabs spaced around a perimeter edge section of the frame portion, the flexible tabs on the perimeter edge section of the frame portion projecting in a direction axially inwardly into the canister and configured and arranged to engage the internal annular rib of the canister when the end closure is attached to the open end of the canister.

30. The filter cartridge as in claim 29, wherein the flexible tabs are evenly spaced around the perimeter edge section of the frame portion.

31. The filter cartridge as in claim 29, wherein the flexible tabs each have a radially outward facing snap tab portion.

32. The filter cartridge as in claim 29, further including a series of axial ribs on the inner surface of the canister terminating proximate the open end of the canister, the flexible tabs arranged to fit between the axial ribs when the end closure is attached to the canister.

33. A filter cartridge comprising:
a filter element located within a canister, wherein the canister includes a canister body with an open end and an end closure, the end closure having:
a central annular element locating feature;
an annular frame portion circumscribing the element locating feature; and
radial support ribs projecting between the element locating feature and the rigid attachment portion of the frame portion, the canister body and end closure having cooperating geometry retaining the end closure to the open end of the canister, the cooperating geometry including:
a series of axial ribs on an inner surface of the canister, each of which has a shoulder at a distal end of each rib proximate the open end of the canister; and
a plurality of flexible tabs spaced around a perimeter edge section of the frame portion, the flexible tabs on the perimeter edge section of the frame portion projecting in a direction axially inwardly into the canister and configured and arranged to engage the shoulder of the axial ribs on the canister when the end closure is attached to the open end of the canister.

34. The filter cartridge as in claim 33, wherein the flexible tabs are evenly spaced around the perimeter edge section of the frame portion.

35. The filter cartridge as in claim 33, wherein the flexible tabs each have a radially outward facing snap tab portion.

36. A filter cartridge comprising:
a filter element located within a canister, wherein the canister includes a canister body with an open end and an end closure, the end closure having:
a central annular element locating feature;
an annular frame portion circumscribing the element locating feature; and
radial support ribs projecting between the element locating feature and the rigid attachment portion of the frame portion, the canister body and end closure having cooperating geometry retaining the end closure to the open end of the canister, the cooperating geometry including:
an internal annular rib circumscribing an inner surface of the canister, proximate the open end;
an external annular rib circumscribing an outer surface of the end closure, the external annular rib of the end closure configured and arranged to engage the internal annular rib of the canister when the end closure is attached to the open end of the canister; and
a plurality of axial locating slots and axial locating tabs spaced apart around a perimeter edge section of the frame portion and an outer edge of the open end of the canister, the axial locating tabs and axial locating slots configured and arranged to interengage to rotationally align the end closure and the canister when the end closure is attached to the open end of the canister.
